(19) United States
(12) Patent Application Publication
(10) Pub. No.: US 2013/0304509 A1
(43) Pub. Date: Nov. 14, 2013

(54) System for Identifying and Delivering Services for Delivery to Pharmacy Patients

(71) Applicant: Philip Alexander, Paddington (AU)

(72) Inventor: Philip Alexander, Paddington (AU)

(73) Assignee: GUILDLINK PTY LTD., Burwood, NSW (AU)

(21) Appl. No.: 13/882,960

(22) PCT Filed: Nov. 9, 2011
(86) PCT No.: PCT/AU2011/001438

§ 371 Date: Jul. 19, 2013

(30) Foreign Application Priority Data
Nov. 9, 2010 (AU) 2010904963

(51) Int. Cl. G06Q 50/24; G06Q 30/06

(52) U.S. Cl. CPC G06Q 50/24; G06Q 30/0631
USPC 705/3

(57) ABSTRACT

A computer system (10) for identifying and delivering services to patients of a pharmacy includes: an information module (20) for obtaining and storing information about a pharmacy patient; an electronic processing tool (22) for processing said patient information from the information module (20) and identifying at least one pharmacy related service program for delivery to a patient qualified for the service program based on said processed patient information; an advisory tool (26) enabling a pharmacy to advise a patient of said identified service program for said qualified patient as identified by said electronic processing tool (22); and a service delivery module (40) for delivering said at least one identified service program to said qualified patient by use of a plug-in application (31-34) corresponding with said identified service program.

This invention relates to a system for identifying and delivering services to pharmacy patients.

Community pharmacy involves, at its core, the safe and effective dispensing of pharmaceuticals to patients. In addition, community pharmacy involves a primary role for pharmacists in the management of health conditions, particularly chronic health conditions and preventative health more generally.

The modern delivery of pharmacy services relies, to a notable extent, on electronic methods and web services for management of prescriptions. For example, US 2003187690, assigned to Medco Health Solutions Inc, describes computer-assisted methods, systems and mediums for providing, to a physician, information relating to a patient. The method comprises the steps of collecting a prescription history that includes information relating to one or more prescriptions issued to the patient and a prescription purchase history, storing the prescription history and prescription purchase history of the patient into a database, and accessing, by the patient, the database for the stored prescription history and prescription purchase history for the patient. The prescription purchase history includes information relating to one or more prescription purchases made by the patient in accordance with the one or more prescriptions. The method also includes the steps of retrieving the prescription history and prescription purchase history by the patient, and communicating, by the patient, the retrieved prescription history and prescription purchase history to the physician physically or electronically in order to assist the physician in providing medical services to the patient.

The system of US 2003187690 has benefits in terms of providing physician, pharmacist and patient with detailed information about prescriptions with a view to providing a more cost effective and economically beneficial way of managing a medication program. Such medication programs are increasingly expensive and management of the related costs is important.

Other computer assisted methods for delivering prescription services and other health services are also described in the literature. Such methods are aimed at improving the efficiency of health service delivery and communications between health professionals and their patients to that end. It is well accepted that such improved communications help in managing national health care budgets, which are an increasing proportion of Gross Domestic Product and, generally, growing at a faster rate than overall economic growth.

Preventative health programs also aim to address healthcare costs through identifying health risks for particular individuals and then tailoring programs to assist those patients manage those health risks. Such programs, while of great importance to the community, in terms of generating health awareness, are usually and necessarily general and informative in nature and not directed to specific patients with specific medical history. Specific medical histories, compounded by complexity of prescription of a range of medications, may make a more customised and specialised approach to preventative health necessary.

In addition, a serious problem surrounds patient non-compliance with medication programs. When a medical condition is diagnosed and a course of medication prescribed, issues may surround administration, by the patient, of less or more than the prescription demands. This is likely to lead to further deterioration in patient health and, across the community, greater healthcare costs. In many cases, patients finding it difficult to comply with prescription programs may find it difficult to identify the problem for a wide variety of reasons. Even where medicines compliance support is provided, a patient may not be able to participate or participate effectively. Effective participation is likely to require pharmacist support particularly where critical program steps must be taken independently by the patient away from the pharmacy environment.

Clearly, the modern pharmacy has much more to offer a community in terms of preventative health and management of health and medical conditions as well as in terms of assistance with medication or medicines compliance. The pharmacy will typically maintain a dispensing system which holds patient prescription histories and other demographic and medical data which could be harnessed to assist medicines compliance and better management of chronic health conditions. However, for a range of reasons but typically resource shortage driven, the pharmacy may not have the resources to harness and apply this data, to its fullest extent, to assist patients with preventative health, management of health and medical conditions; and medicines compliance through programs that may be available to assist with those issues.

It is an object of the present invention to provide a system for identifying patients who may benefit from participation in pharmacy related programs, such as preventative health, management of health and medical conditions and medicines compliance programs though not limited to these, and which assists pharmacists and other health professionals to assist patients through facilitating patient participation in such programs.

With this object in view, the present invention provides, in one aspect, a computer system for identifying and delivering services to patients of a pharmacy, the computer system including:

an information module for obtaining and storing information about a pharmacy patient;

an electronic processing tool for processing said patient information from the information module and identifying at least one pharmacy related service program for delivery to a patient qualified for the service program based on said processed patient information; and

an advisory tool enabling a pharmacy to advise a patient of said identified service program for said qualified patient; and

a service delivery module for delivering said at least one identified service program to said qualified patient by use of a plug-in application corresponding with said identified service program.

In a further aspect, the present invention provides an electronic processing tool for processing information about a pharmacy patient to identify a service for delivery to said patient; information for processing being obtained from an information module for obtaining and storing information about the pharmacy patient, the processing tool being communicable with an advisory tool enabling a pharmacy to advise the patient of a suitable service program for delivery to the patient and a service delivery module for delivering said service program to said patient by use of a plug-in application corresponding with said service program.

In a still further aspect, the present invention provides a method for identifying and delivering services to patients of a pharmacy comprising

obtaining and storing information about a pharmacy patient in an information module;

processing said patient information from the information module using an electronic processing tool and identifying at least one pharmacy related service program for delivery to a patient qualified for the service program based on said processed patient information;

advising a patient of said identified service program for said qualified patient; and

delivering said at least one identified service program to said qualified patient from a service delivery module by use of a plug-in application corresponding with said identified service program.

Plug-in applications, which also compendiously includes add-ons, snap-ins and themes, are software components (or sets of software components) which enable pharmacies to deliver customised pharmacy related service programs, in a range of possible formats, to qualified patients. Such plug-in applications are typically developed external to the pharmacy by a third party which may have no direct commercial relationship with the pharmacy. Use of such plug-ins considerably extends the capability of typical pharmacy computer resources to provide service programs that enhance patient health and wellbeing.

To optimise such benefit, each pharmacy related service program conveniently forms part of a range of available service programs deliverable, to qualified patients, through the computer system. So, the at least one service program may be identified from a plurality of deliverable service programs, any of which would be identified by those skilled in the art as falling within the effective practice of community pharmacy.

Pharmacy related service programs that may be delivered to patients include, without limitation, preventative health programs, programs for management of health and medical conditions from a community pharmacy perspective. and medicines compliance programs. Services may include provision of advice or recommendation of a particular diagnostic or therapeutic test or procedure. The system may also support treatment of disease and identification of clinical trial programs suitable for particular patients. The system may identify and, sometimes provide, programs associated with management of specific conditions such as diabetes, asthma, heart conditions, other disease, abnormal weight and so on. The available programs may extend well beyond the important dispensing service though patient qualifications for enrolment in program(s) will typically be derived, at least in part, from patient prescription history.

Service programs identified and delivered by the system should also include a medication adherence program, as medication adherence is of critical importance. On medication adherence, it has been found that many patients fail to comply with a schedule of prescriptions made for them by a medical practitioner. Such lack of compliance may be determined by calculating a patient's medicines possession ratio, such as a MedsIndex® score. However, a patient requiring support through a medication adherence program may also benefit from participation in other service programs as above described.

Effective delivery of service programs is likely to require support and supervision from pharmacy personnel. In most cases, the patient will not benefit, or will benefit insufficiently, from independent patient access to the computer system and its deliverable suite of service programs. Professional assistance will be required with the computer system supporting the delivery of such professional assistance. Therefore, the computer system is preferably accessible only through a pharmacy computer under professional supervision.

The information about a patient may be obtained and stored in the information module through a computer interface at a pharmacy, for example a pharmacy workstation computer. The information module conveniently comprises a first database correspondent with the pharmacy and configured to store patient information for that pharmacy, typically over a period of time. The information module and first database, in this case, conveniently forms part of the computerised information system or dispensing system of the pharmacy.

The electronic processing tool of the computer system may be interfaced to the information module to allow a range of information from the first database to be processed for a single patient or a group of patients. The electronic processing tool could also be provided with its own database(s) of patient information for processing. Though such information is most easily obtained from the dispensing system, through an interface as referenced above, it may be obtained by other means. Therefore, the information module may include a database held in the electronic processing tool. The information to be processed may be filtered in some way. For example, the system may only seek and process information relating to patients over a particular period of time or for patients prescribed a particular medication. This information is then processed by the electronic processing tool.

The information may be obtained by pharmacy personnel during a patient visit to a pharmacy for example to receive a dispensing service. The identified service, for example blood pressure measurement as part of a blood pressure monitoring program, may be delivered during a single patient visit to a pharmacy in some cases.

Processing of patient information, by the electronic processing tool, may occur in background even while the system processes patient information and identifies services for delivery to patients visiting the pharmacy. That is, the system allows a number of patient information processing tasks to be performed simultaneously. The computer system allows patient information to be processed by the electronic processing tool and an appropriate service for the patient to be identified in real time, that is during the patient's visit to the pharmacy.

Conveniently, however, the electronic processing tool has a database, as above described, which can store patient information, at least for a period of time—typically in the order of 7 days—and this allows for electronic processing to occur during quieter periods or out of business hours limiting the load on the computerised dispensing system of a pharmacy. Such electronic processing does not require the presence of pharmacy personnel.

The information about the patient obtained and stored by the information module may be compared, by the electronic processing tool, with one or more qualifications for admission to a program for delivering the patient a service. Qualifications are pre-conditions that require to be met for a patient to be enrolled within a particular pharmacy related service delivery program. In this case, the processing tool acts as, or includes, a qualification tool. Qualifications may be quantitative or qualitative in nature. An example of a quantitative qualification would be high blood pressure. Qualitative qualifications would typically be based on a pharmacist's professional assessment following an appointment/discussion with a patient rather than on numeric criteria derived from pathological or other testing. Qualifications for enrolment in a service program are likely to include both quantitative and qualitative qualifications.

In the case where the processing tool acts as a qualification tool, most qualifications for admission to a program may already be stored in the first database, or—more preferably—in the database of the qualification tool itself, when the qualification tool is operated. However, the system allows for final qualification(s) to be input to the system after inquiry of the patient by pharmacy personnel. When this information is provided, it—or a system selected portion of it—may be passed for processing by the qualification tool.

The processing tool is interfaced to process information obtained from the information module/first database to identify patient information relevant to a particular service program. This patient information may then be compared with information about pharmacy related service programs, deliverable by the service delivery module, and held on a second or service database. Qualified personnel, particularly pharmacist(s), may identify pharmacy related service program(s) suitable for a particular patient and initiate the comparison process ad hoc. For example, if a patient has difficulty with complying with a medication program, whether that difficulty concerns one or more medications that may be the subject of particular compliance programs, that patient may be a candidate for clinical intervention and enrolment in a suitable support service program.

When the processing tool of the computer system identifies patient candidate(s) for enrolment in a pharmacy related service program and the patient enrols, the service program is advantageously delivered through the patient's own pharmacy and conveniently through the pharmacy dispensing system. The second or service database and service delivery module could, with the first database, also form part of the pharmacy dispensing system. However, not all pharmacies are capable of delivering a wide range of pharmacy related service programs. Not all pharmacies will hold information about suitable pharmacy related service programs for all of the patients they serve. Some pharmacy related service programs may also be highly specialised and not relevant to more than a few patients at a particular pharmacy. Therefore, the computer system advantageously provides such service programs, as are required or subscribed to by a particular pharmacy, to a pharmacy through controlled communication between a pharmacy dispensing system and a service computer system (including the second database and service delivery module) through a data network which should be a secured data network whether through the internet or other type of network, for example an ADSL network. Conveniently, the service computer system comprises a web server (making the system web based) and made accessible to a pharmacy or a network of pharmacies through the internet.

In this embodiment, the second database may be configured to store information about a wide range of pharmacy related service programs because the pharmacy network will likely have a sufficient cohort of patients to justify delivery of a more complete range of patient service programs. The service computer system provides information about selected patient service programs to the pharmacy dispensing system based upon patient information as provided to it and pharmacy demand for service programs. A pharmacy need not be supplied with information about all the service programs catalogued on the service computer system. A pharmacy may only be supplied with information about a sub-set of such service programs, this sub-set dependent on the pharmacy's requirement for specific service programs which may be linked to payment of subscription fees. The patient can then be informed by a pharmacy about suitable available patient service programs—and any actions required by the program of a patient at the time of a pharmacy visit. The information may conveniently be displayed at a computer workstation (acting as advisory tool) within the pharmacy. The information may be in a form suitable for display to patients either at the pharmacy or when remote from the pharmacy. The computer system should only be accessed through workstations that are registered or permitted to access the system.

In some cases, a patient consent step may be required prior to enrolment in the pharmacy related service program. Consent may itself be a qualification for participation in a service program.

When the patient consents to, or opts into, enrolment in a service program, the first database is updated with that information. Such consent/opt in program applies to each program applicable to an individual patient. An individual patient may potentially qualify for more than one service program. A case record, correspondent with the patient's enrolment in the service program is, following the consent or opt in step, also created in the second database. Patient personal information should only be communicated to the second database following the consent or opt in step (noting that consent may be express or implied).

At this point, delivery of the patient service program through use of the plug-in application corresponding with the service program may commence. The plug-in application or program is downloaded, on request from a pharmacy workstation to the pharmacy computer system, ideally the dispensing system, through a secured data network whether web based (internet) or otherwise. Where the system, as most convenient, is web based, pharmacy personnel may select the required service program, perhaps from a drop down box or similar, and this sends a URL request for downloading of the plug-in program to the web server.

During delivery of the pharmacy related service delivery program, the patient's record both in the first database and the service delivery module may be updated for example by authorised request at a pharmacy workstation. Such updates may occur in real time.

The computer system allows for synchronisation of patient information between the first and second databases when a case record for a patient participating in a service program exists within the second database. This allows for more effective delivery of a service program to patients because the service is delivered on the basis of the most up to date, and accurate, information about the patient, this information being collected during delivery of the service programs.

The computer system may periodically be updated with, or access plug-in applications corresponding with, new or amended service programs and the processing tool is then updated to enable these service programs to be delivered, through the service delivery module, to patients identified as qualified for enrolment in the programs. This is convenient system because programs need only be updated at one point, keeping program information up to date for all pharmacies using the system. Inconvenient pharmacy by pharmacy updates, as necessary with much software, are avoided. Rather, when a pharmacy accesses a plug-in application for use in delivering a service program to a patient, the plug-in is accessed in the form as intended by its developer.

The computer system may be a subscription system, the service programs available for delivery to patients being selected in accordance with the subscription taken up by the pharmacy with a third party provider of the electronic processing tool and service computer system.

The computer system may notify pharmacy personnel if a patient qualifies for a program but is not yet involved. Such notification may act as a prompt for qualified personnel to provide further information about a program to the patient. The system may enable notification to be provided to a patient for a selected period of time or for a selected number of patient visits to the pharmacy.

If the patient attends more than one pharmacy, the patient may obtain multiple enrolments in programs about which the second database holds information. This is not prevented by the computer system. The computer system does not share information between pharmacies.

The system provides information to pharmacists and other qualified personnel as a basis for further actions or clinical interventions, for example actions to address a chronic health problem such as asthma, diabetes or high blood pressure. The system visually displays the information in a report format which may also be printed as needed. The system may include a patient interface which enables the patient to view information relevant to the program(s) in which the patient is enrolled.

The computer system and electronic processing tool will be more fully understood from an embodiment described in the following non-limiting description. The description refers to the following representations in which:

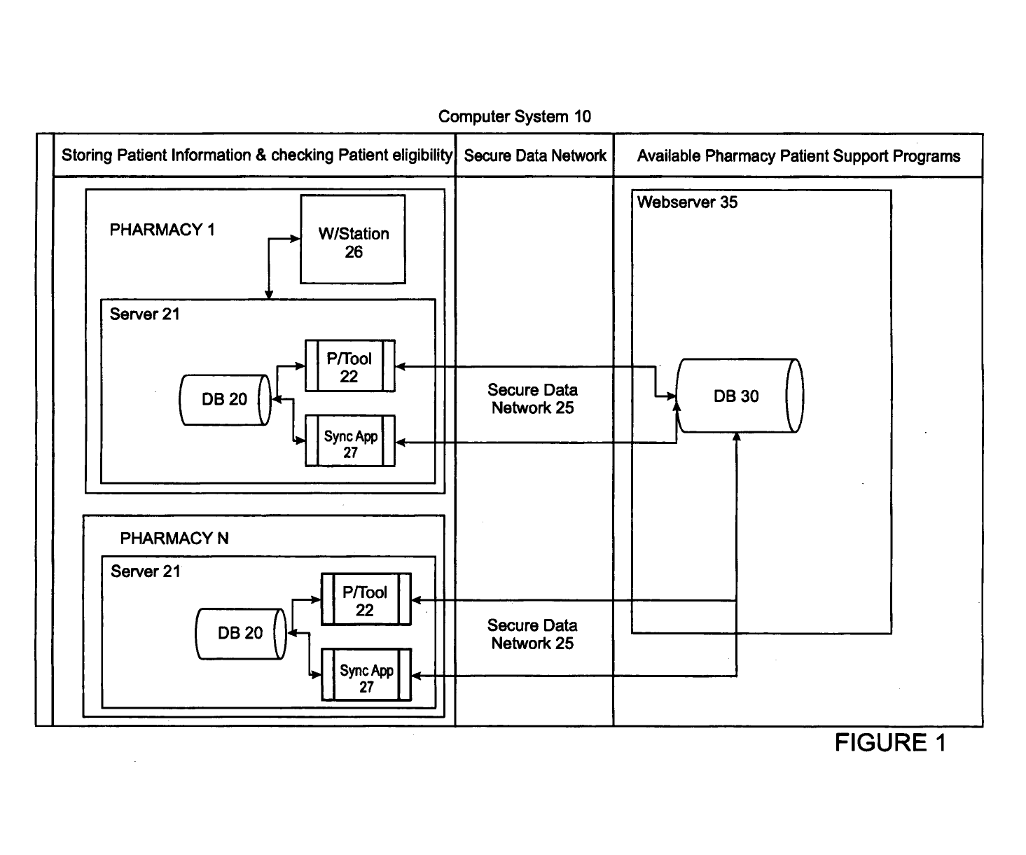

FIG. 1 is a schematic illustration of the computer system for identifying patient candidates for a medicines compliance program in accordance with one embodiment of the present invention;

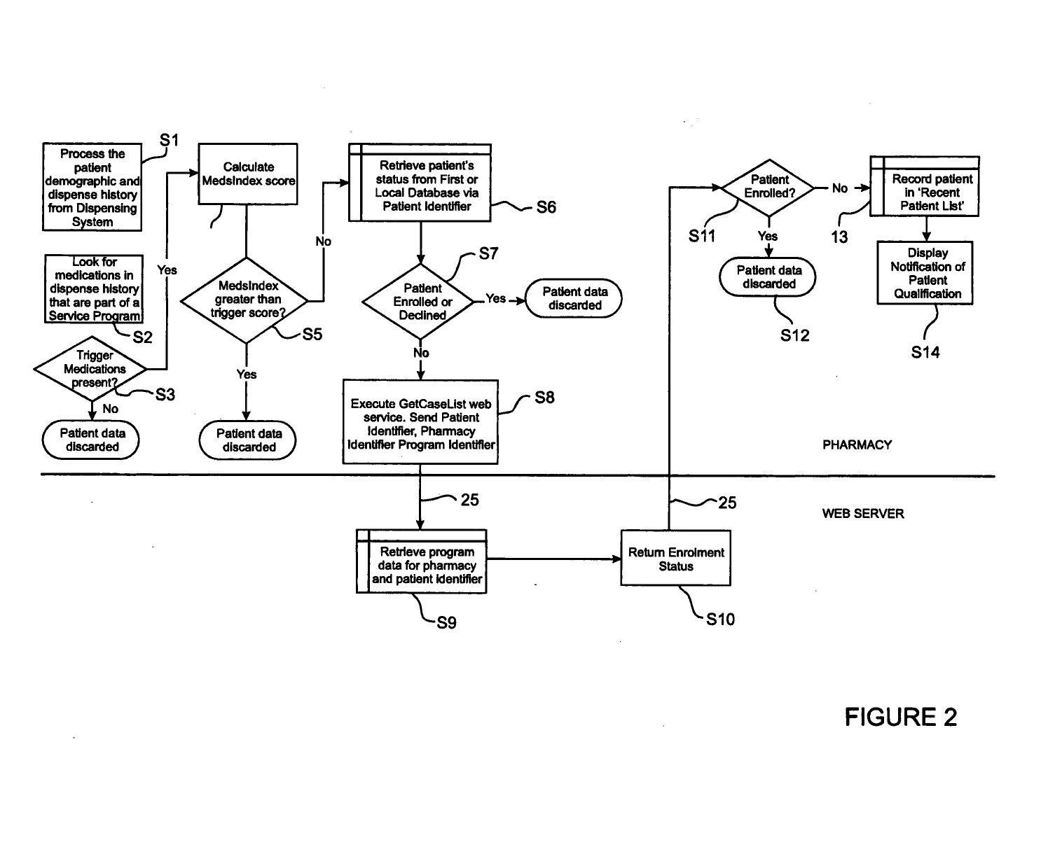

FIG. 2 is a flowchart for showing initial steps for identifying patient candidates for enrolment in a medicines compliance program in accordance with one embodiment of the computer system of the present invention;

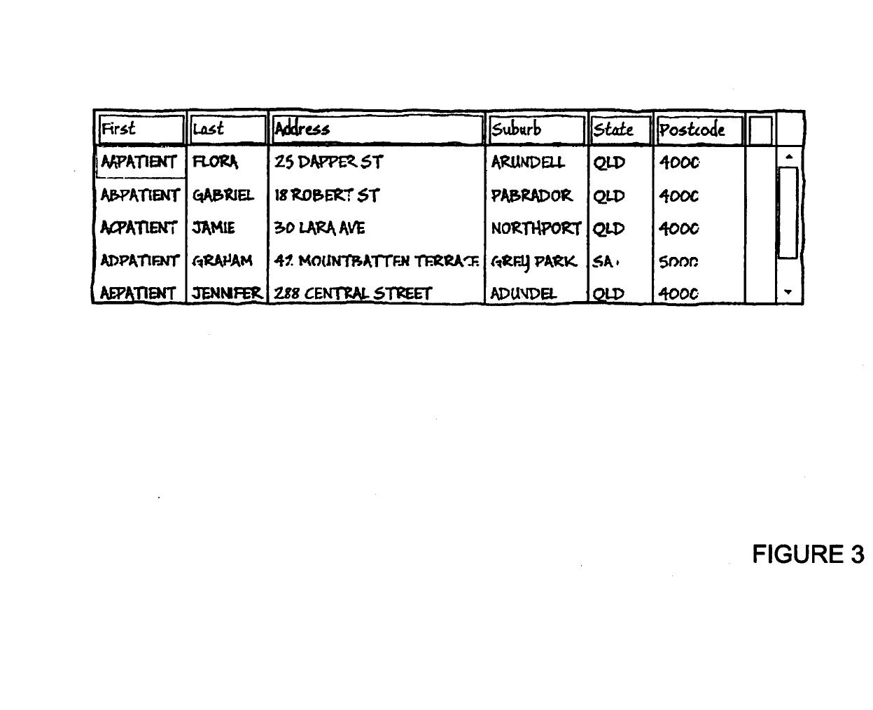

FIG. 3 shows a pharmacy workstation screen display showing a listing of patients and certain demographic data as held in the first database of the same computer system referenced in FIGS. 1 and 2;

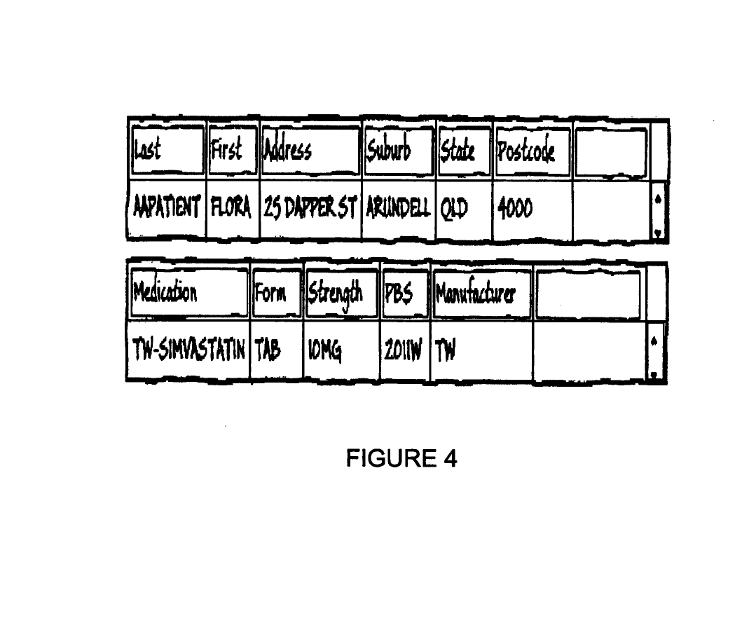

FIG. 4 shows a subsequent screen display at the pharmacy workstation showing information about medicines prescribed to a patient and held in the first database of the same computer system referenced in FIGS. 1 to 3;

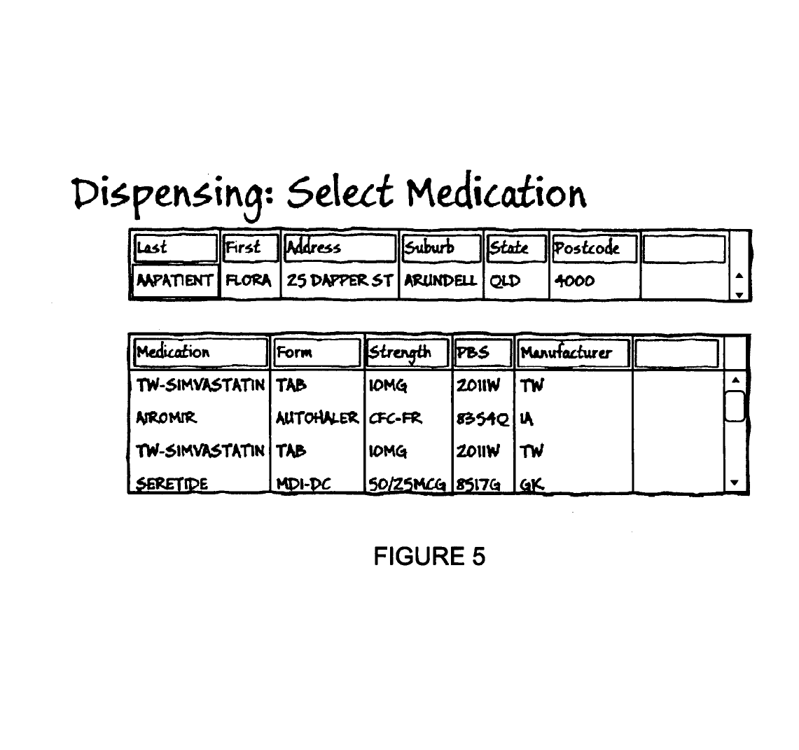

FIG. 5 shows a pharmacy workstation screen display showing a medicine subject of a compliance program and prescribed to the patient referenced in FIGS. 3 and 4.

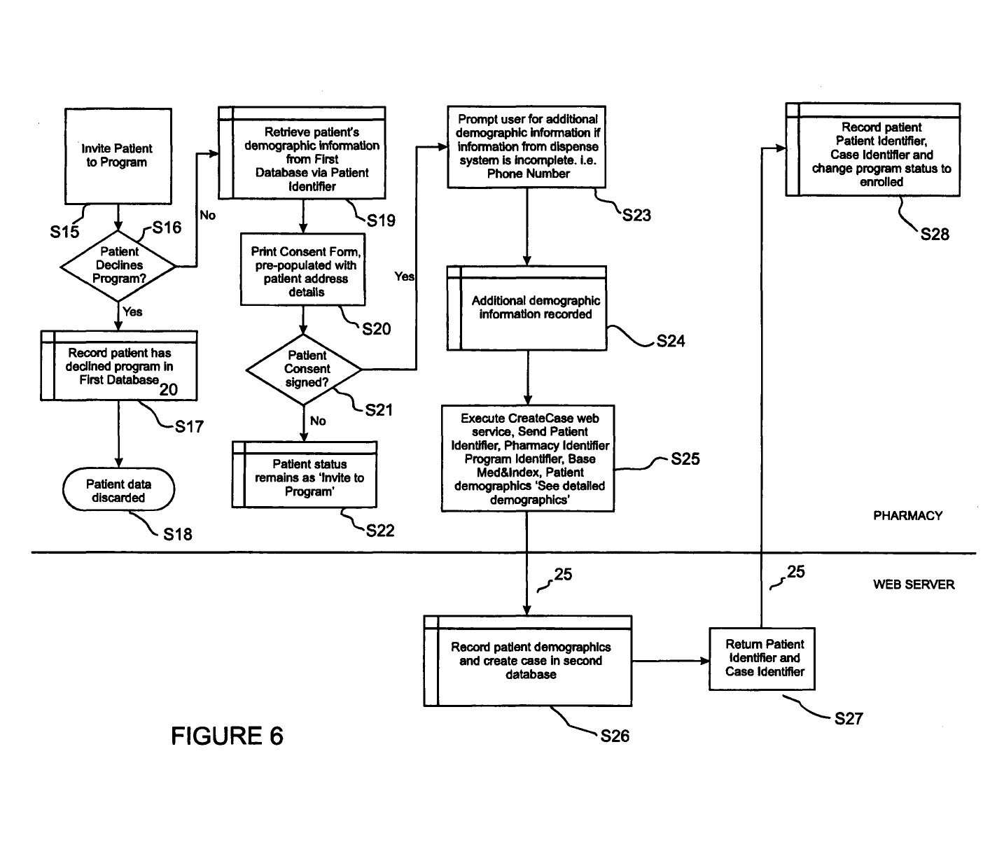

FIG. 6 is a flowchart showing further steps involved in inviting and enrolling a patient, following patient consent, in a medicines compliance program provided by the computer system;

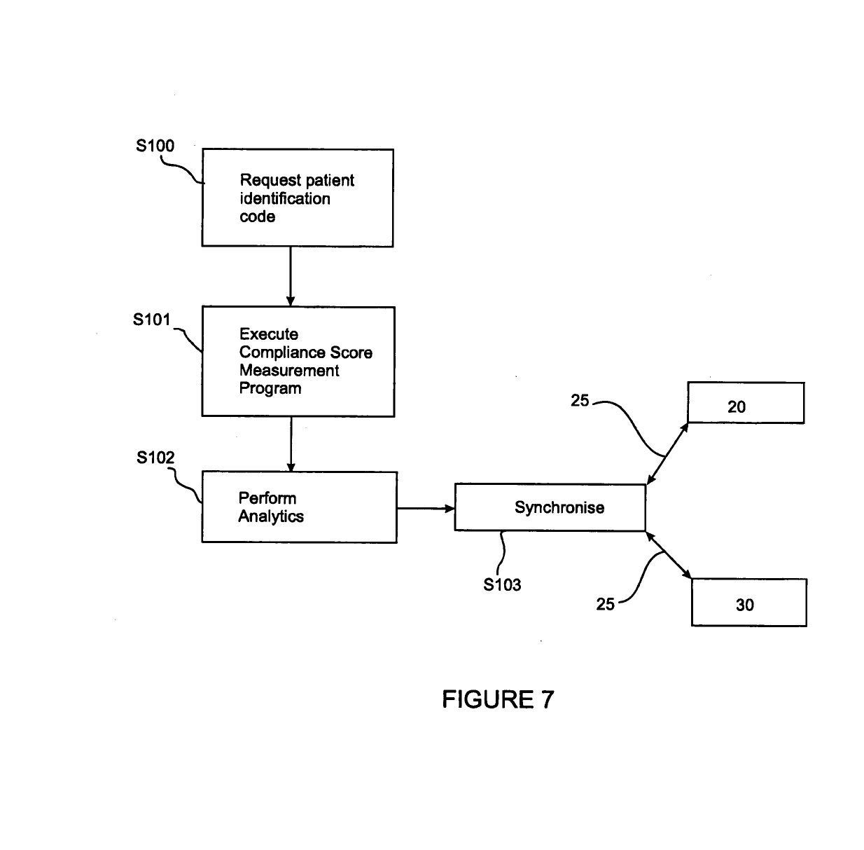

FIG. 7 shows a flowchart for synchronising data between first and second databases of the computer system illustrated with reference to FIGS. 1 to 6;

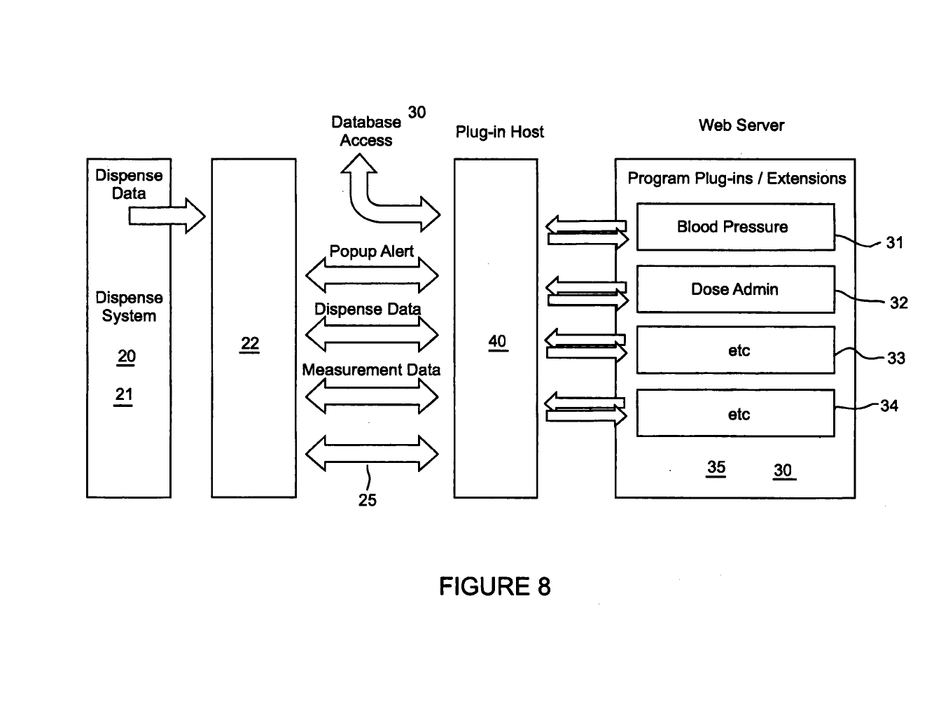

FIG. 8 is a schematic showing how the computer system delivers web based pharmacy related services to the dispensing system of a pharmacy;

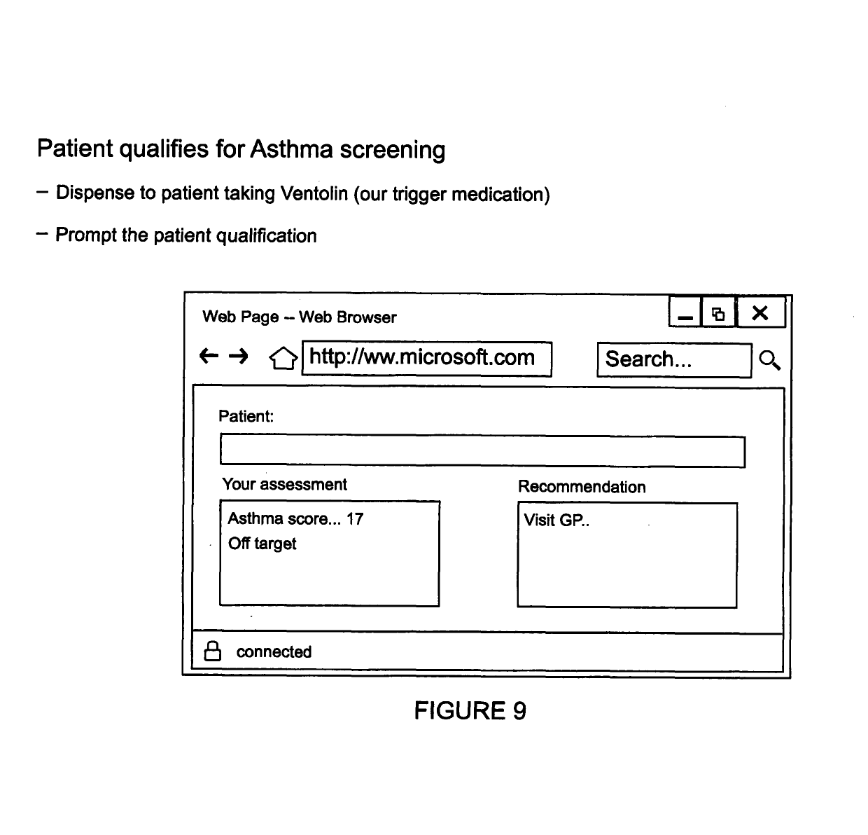

FIG. 9 is a pharmacy workstation screen display during running of an asthma screening program;

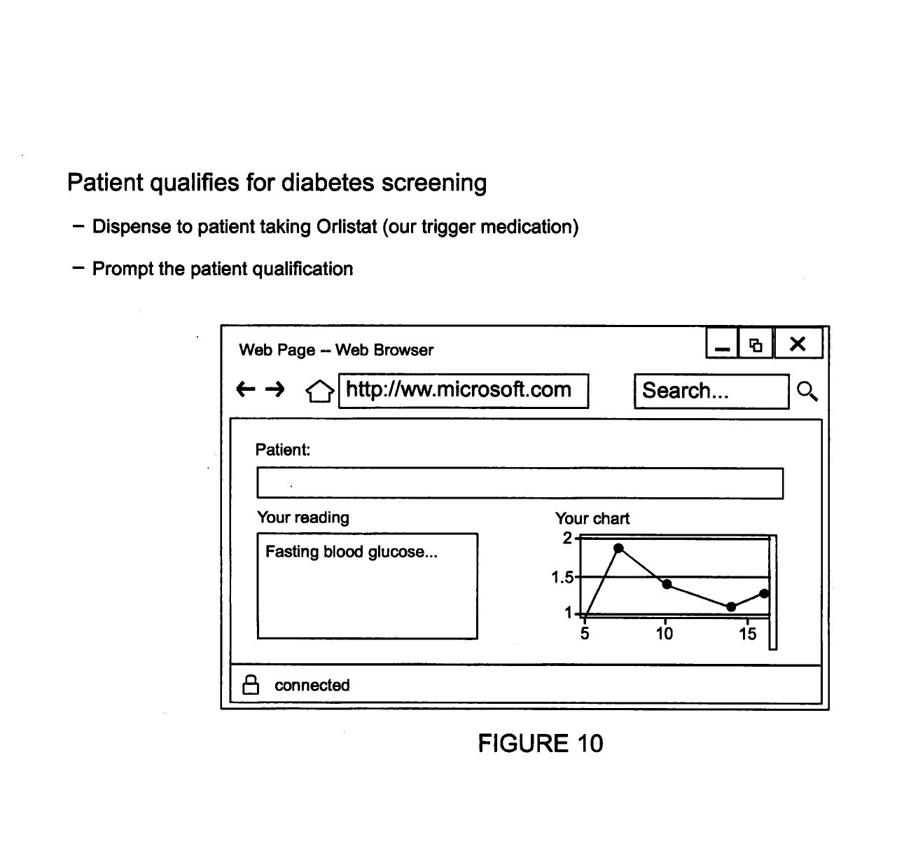

FIG. 10 is a pharmacy workstation screen display during running of a diabetes screening program for a patient;

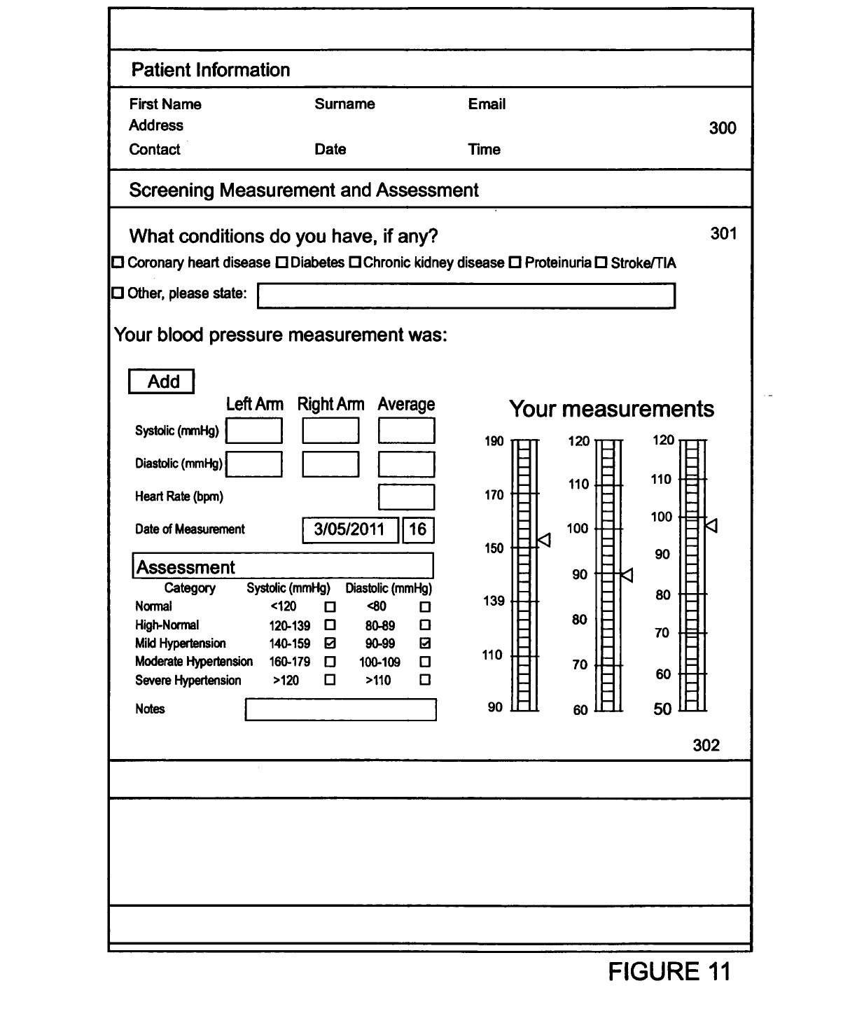

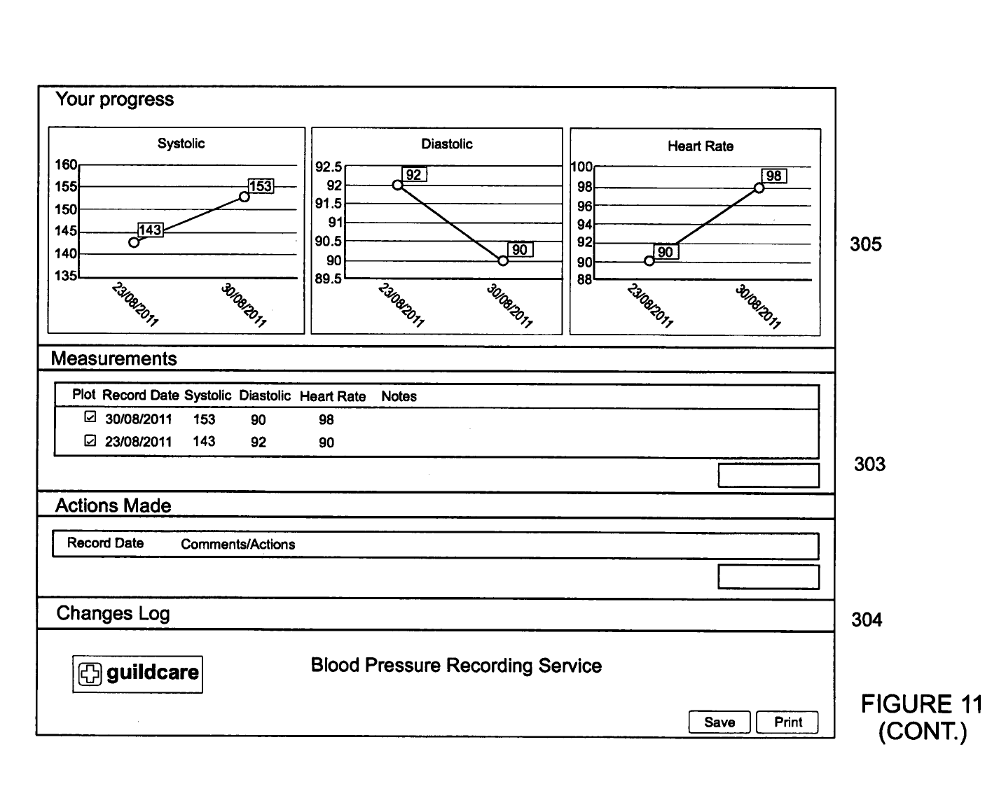

FIG. 11 is a pharmacy workstation screen display during running of a blood pressure monitoring program; and

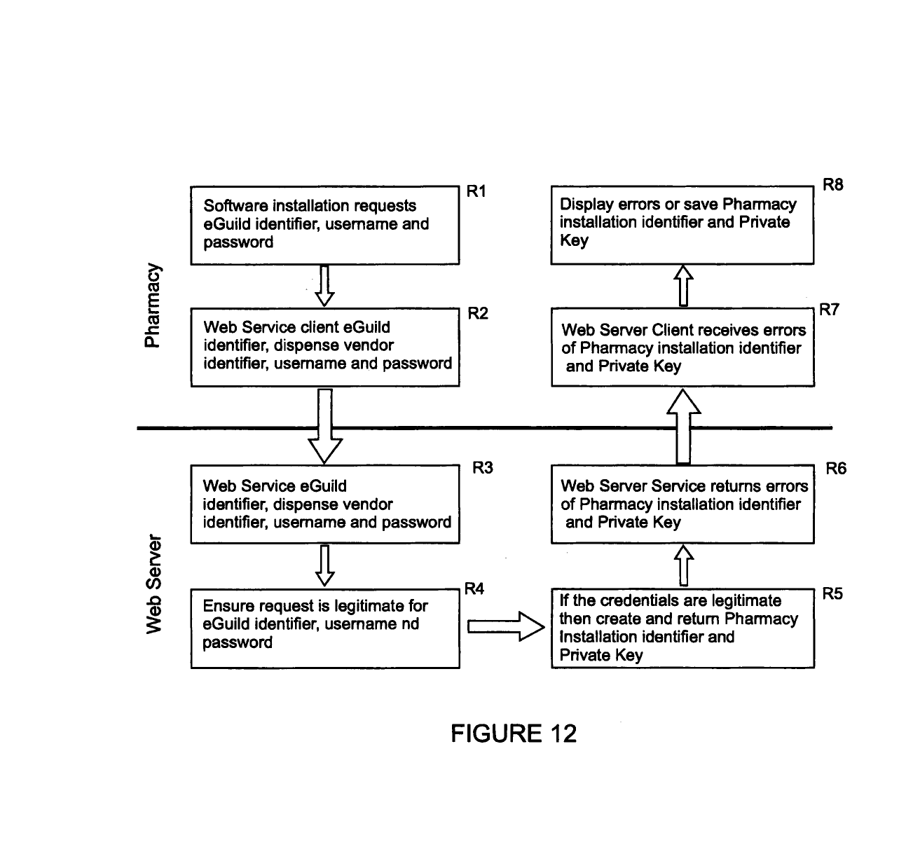

FIG. 12 is a block diagram showing registration of a pharmacy workstation for access to the computer system.

Referring first to FIGS. 1 to 7, there is shown the implementation of a computer system 10 for identifying a service program for delivery to a pharmacy patient. For the purposes of illustration, one available pharmacy related service program available to a qualified patient is a medicines compliance program based on a patients monitored medicines possession ratio, such as that supplied under the MedsIndex® trade mark. This is not intended to place any limitation on the pharmacy related service program, whether medicines compliance oriented or otherwise, that may be delivered by the computer system 10. Indeed, computer system 10 delivers a range of pharmacy related service programs intentionally not limited to medicines compliance, as described below. The service programs are a sub-set of a broader range of service programs deliverable by computer system 10.

The computer system 10, as schematically shown in FIG. 1, includes: an information module for obtaining and storing patient information, here including a first database 20 configured to store patient information; and an electronic processing tool 22 interfaced to the first database for processing the patient information to assess whether delivery of a particular patient support service program is appropriate. Electronic processing tool 22 was installed by a third party on the pharmacy's request to implement computer system 10. The pharmacy may itself obtain the electronic processing tool and instal it. If such processing results in identification of an appropriate deliverable service program, the pharmacy will be advised by an advisory tool 26 communicable with the processing tool 22 as described below.

In this case, the processing tool 22 compares patient information stored in the first database 20 with one or more qualifications for admission to a patient service program. Information about the patient service program is contained on a second database 30 configured to store information about pharmacy patient support programs and including information about the medicines compliance program. As patient information maintained in the first and second databases 20 and 30 is, by nature, confidential, and often sensitive as well, the first and second databases 20 and 30 communicate via processing tool 22 through a secured data network 25. For example, firewall protection and data encryption may both be in place. An alternative is for patient information to be extracted to a database included within processing tool 22, information in this database being compared with qualifications for admission to a patient service program.

Second database 30 is hosted on a web server 35 so the computer system 10 involves provision of web based services. Indeed, this is a very important feature of the computer system 10 due to its use of plug-in applications, as described below, in delivery of service programs to patients. Second database 30 may be accessed through secured data network 25 by a number (“N”) of pharmacies present in a network of pharmacies supported by computer system 10. The second database 30 may not be directly connected to each of the pharmacies. Communication may be through one or more intermediate computers or servers.

The first database 20 forms part of the dispensing system of a pharmacy and it is held on dispensing system server 21. Server 21 may be held on site at the pharmacy or remotely. This is not important. The first database 20 simply corresponds with the pharmacy serving a particular patient or group of patients. As part of the dispensing system 21, the first database 20 holds a range of patient demographic or personal information which is held in a patient record to which a unique identification code is assigned. The first database 20 also holds medication or prescription history information including nature of prescriptions submitted and filled. Such history information is viewable on a screen display at pharmacy workstation 26.

Processing tool 22 is also hosted on the dispensing system server 21, for example being installed on a hard drive of that server 21 following a pharmacy's subscription to the patient service identification and delivery system 10. In the case of medicines compliance, the qualifications—or preconditions that require to be met for a patient to be enrolled within the medicines compliance program—are not especially detailed or onerous as failure to take medicines as prescribed is a widespread and serious problem. However, certain groups within the patient population are more likely to have difficulty with compliance than others and the qualifications may be targeted to identification of patients within these groups.

The processing tool 22 identifies patients who have the qualifications for admission to a support program through comparison of patient information with qualification criteria. To that end, the processing tool 22 interfaces with the first database 20 to identify patient information relevant to a particular patient support program. This patient information may then be compared with the information about patient support programs held on the second database 30. This may be done, depending on the analytics required, by the processing tool 22 which stores the relevant patient information in its own database for comparison with patient support information held on the second database 30. Qualified personnel, and in particular pharmacist(s), may identify pharmacy related service program(s) suitable for a particular patient and initiate the comparison process. For example, if a patient has difficulty with complying with a prescribed medicines regimen, as measured by a medicines possession ratio (such as a MedsIndex score), that patient may be a candidate for enrolment in a medication adherence program.

Referring more specifically now to FIG. 2, there is described the steps in the identification of patients for enrolment in a medicines compliance program. In step S1, the processing tool 22 processes patient demographic and dispense history as held on the first database 20. Such information includes patients' names, addresses, current medications and other dispensing data.

FIG. 3 shows a screen, visible to the pharmacist at his/her workstation 26, with a listing of pharmacy patients and held in the first database 20 of the pharmacy dispensing system server 21 together with other demographic information including addresses.

In Step S2 the processing tool 22 compares the patient's current medications with medications that are subject of a medicines compliance program. For example, Flora has been prescribed a number of medicines, as illustrated by the pharmacy workstation 26 screen display provided as FIG. 4, including simvastatin, merely by way of example. The specific medicine simvastatin is subject of a medicines compliance program as illustrated in FIG. 5.

Step S3 confirms that Flora has been prescribed a medicine subject of the compliance program. This is the first qualification for Flora's enrolment in the medicines compliance program. Had Flora or one of the other patients not been prescribed a medicine subject of the program, data arising from the qualification activity would be discarded at step S3 as no relevant compliance program is available. It is to be understood that the processing tool 22 may operate on a batch basis checking medications and patient data for a number of patients, potentially a large number of patients. These patients may be grouped by common prescription of a trigger medication, the concept of trigger medication being described below in the context of asthma and diabetes screening programs available through computer system 10. The illustration of the operation of computer system 10 for one patient is merely for purposes of clearer explanation.

Flora may qualify for a medicines compliance program. At step S4, Flora's MedsIndex® score for simvastatin, over the previous 12 months, is calculated on the basis of Flora's personal information and 12 months of medication history as indicated in FIG. 5. The MedsIndex® score provides a patient a simple score out of 100 for a prescribed medication. Flora's score is calculated by monitoring repeat refill intervals of the simvastatin medication and reporting against expected refill intervals based on a doctor's instructions.

At step S5, Flora's calculated MedsIndex score® is compared with a trigger score. If Flora's MedsIndex® score is greater than a trigger score, the qualification data compiled to this point in the process is discarded. However, if Flora's MedsIndex® score is less than that trigger score, Flora has met a further qualification for enrolment in a medicines compliance program web accessible through computer system 10. This is the second qualification for Flora's enrolment in a medicines compliance program to help her improve her medicines compliance.

At step S6, Flora's program enrolment status information is retrieved. This involves matching of program enrolment status with data held in a record containing Flora's unique identification code. At step S7, Flora's enrolment status is checked. If Flora is already enrolled in the program, has declined enrolment or perhaps has not met other qualifications for enrolment previously, qualification data to this point is discarded either immediately or after a predetermined period of time, say 7 days.

If not, Flora's unique identification code, pharmacy identification code and program identification code, as retrieved to step S7, is sent, in an enrolment status request step S8, to web server 35 for checking against information held in second database 30. Such check, which is optional and less preferred for system performance reasons than checking of first database 20 records, assesses whether Flora is already enrolled in a medicines compliance program as documented on second database 30 held on web server 35. For step S9—retrieval and checking of records—to take place, the computer system 10 requires authentication of the request at step S8. This requires matching of the requesting pharmacy's identification code with those pharmacies registered to access the second database 30. Flora's unique identification code—for example a numeric code—is also matched with records held in the second database 30. If, as is usual, the request is sent from pharmacy computer workstation 26, the computer system 10 will require that the computer workstation 26 be registered in accordance with the protocol described below. The request will be sent through secured data network 25. The pharmacy initiates this request process. This is not coincidental. The computer system 10 is specifically designed, for security reasons, so that inquiry is not made of first database 20 by web server 35 when candidate patients for enrolment in a medicines compliance program are being identified.

When these conditions are met, Flora's enrolment status information is returned, through the secure data network 25, to the pharmacy dispensing server 21 in step S10. At step S11, computer system 10 checks whether Flora is already enrolled in a medicines compliance program concerning simvastatin. If so, qualification data to this point is discarded in step S12. If not, Flora is recorded in dispensing system server 21 as a candidate patient for the program at step S13. The pharmacist is informed, by the advisory tool of the system 10, of Flora's candidacy for enrolment in a compliance program at step S14. In this case, the advisory tool is conveniently the pharmacy workstation computer 26. An audible confirmation of Flora's status may be provided together with visual display on the pharmacy computer workstation 26. Flora can then be informed of her candidacy for a suitable support program by the pharmacist when, for example, being provided a dispensing service.

Referring now to FIG. 6, the invitation, consent and enrolment steps of the computer system 10 are described. At step S15, the pharmacist—now aware of Flora's candidacy for a medicines compliance program—invites Flora to enrol in the program.

At step S16, Flora decides whether she wishes to enrol. If Flora declines, the first database 20 is updated, in step S17 with Flora's decline and qualification data to this point is discarded at step S18.

If Flora wishes to enrol, her demographic information—matched with Flora's unique identification code—is retrieved from the first database 20 in step S19. A consent form—pre-populated with Flora's name and address data—may be printed and handed to Flora for her signature in step S20. Flora may still decline enrolment in the medicines compliance program at step S21 but, if she does, first database 20 will still record patient status as an ‘invite to program’ at step S22. Flora may be followed up on her future visits to the pharmacy. Computer system 10 does not always require patient consent. Some patient support programs, for example blood pressure monitoring, do not require consent. In other cases, consent may be implied.

If Flora consents, the pharmacist is prompted for any missing demographic information that may be needed for effective enrolment in the medicines compliance program at step S23. For example, Flora's phone number or some other like information may be missing. Such additional information, when supplied, is input at pharmacy workstation 26 and recorded in first database 20 at step S24.

At step S25, Flora's enrolment information including:
Demographic information;
Program identification code; and
Base MedsIndex score
   and linked with her identification code and the pharmacy identification code is sent through the secure data network 25 to web server 35.

A new case record for Flora, containing the above information, is opened—with her program identification code—in second database 30 at step S26. At step S27, Flora's program identification code and her numeric identification code, as recognised by her pharmacy, is returned through the secure data network 25, to the dispensing system server 21 for the pharmacy. This information is recorded in first database 20 at step S28.

Flora then participates in the medicines compliance program. Whilst Flora and other patients participate in a medicines compliance program linked with particular medications, for example simvastatin, their script history needs to be updated between the first database 20 and the second database 30 located on the web server 35. This is a necessary step for the medicines compliance program to be conducted and to provide helpful information to the pharmacist about Flora (and other patient) medicines compliance status. To do this a synchronisation application 27, as now described, is executed by computer system 10.

The synchronising application 27 is installed on the dispensing system server 21, holding the first database 20; it provides a service for synchronising patient demographic and dispense history between the dispensing system server 21 and the second database 30 located on web server 35. Synchronising application 27 is executed via a scheduler and performs the following actions, as schematically illustrated in the flowchart of FIG. 7, on properly authenticated request from a pharmacy registered for access to computer system 10:
1. Step S100: Requests a list of enrolled patient identification codes, including Flora's code, from the web server 35 holding the second database 30.
2. Step S101: Executes the program, which may be supplied by the pharmacy, for measuring medicines compliance with a list of medication identification codes. The program retrieves patients and prescription history from the first database 20 that have the listed medication in their prescription history.
3. Step S102: Performs analytics on the patient information to determine the level of adherence to the listed medications, for example by calculating a MedsIndex® score.
4. Step S103: Synchronisation of dispense history for patients enrolled in the compliance with the second database 30 via the secure data network.

Synchronisation also involves updating of system information such as declining patients, patients invited to programs and so on so that information held on the first database 20 and the second database 30 is consistent.

Pharmacy related service programs are delivered through a computer system 10 via a web based application which provides plug-in applications corresponding with particular service programs to the computer systems of participating pharmacies. In such case, the programs are deployed, as illustrated schematically in FIG. 8, through a service delivery module or host application 40 with each service program: medicines compliance, blood pressure monitoring and so on, being delivered as a plug-in to the host application 40 intermediate web server 35 and dispensing system 10. Each plug-in application or program 31 to 34 is downloaded via secure data network 25 to the pharmacy dispensing system server 21 on demand. That is, in Flora's case, once enrolled in an electronically deliverable medicines compliance program, the computer system 10 allows the pharmacy to access the medicines compliance program, on Flora's behalf through the plug-in methodology.

The host application 40 provides common services to the plug-in, about which information is held on the second database 30, such as:
Access patient and dispensing history
Access to pop-up alerts which may be relevant to delivery of the program
Sending program status messages
Access to the second database 30 storing information about the pharmacy related service programs and allowing these to be executed as required
Synchronisation of information between first database 20 and second database 30 as described above.

Information held on second database 30 is more comprehensive than the information held in first database 20. So, detailed data acquired during running of a patient support program, such as measurements and so on, is not written back to the first database 20. First database 20 and so dispensing system 21 keeps a summary of this information including current status, next action required etc.

A suitable plug-in based application framework for delivering the plug in programs is provided in this case by Microsoft Silverlight® and managed extensibility framework. This application framework allows development of plug-in applications corresponding with pharmacy related service programs in a variety of possible languages which may be selected by the developer. C# or Visual Basic are two examples, C# being preferred in this case. At the same time, the plug-in based application framework is compatible with a range of operating systems (as described in Microsoft Silverlight® support material, such as its website, and the contents of which are hereby incorporated herein by reference) and therefore accessible to all N pharmacies of the pharmacy network supported by computer system 10. Plug-in application frameworks other than Microsoft Silverlight® may be employed. However, it is important that such programs allow rich internet applications to be achieved.

The plug-in application framework, rather than sandboxing the web based pharmacy related service programs, allows a limited amount of communication between dispensing system 21 and web server 35 enabling the computer system 10 to operate as above described. Use of a plug-in application framework extends the capability of the dispensing system 21 to deliver service programs to patients and in a typically attractive and powerful rich internet format using, as required, templating, styling, multimedia, streaming, search engines and themes. There is no requirement for the dispensing system 21 to be programmed, potentially expensively, with extensive new code in order to deliver the service programs to patients.

At the pharmacy computer workstation 26 level, system 10 is forms based. However, the system 10 allows for seamless delivery of the web based services, as subscribed to by the pharmacy, to the pharmacy workstation and, more particularly, the browser of the workstation computer 26. In this sense, system 10 involves a hybrid application that is both forms and web based, downloads of service programs to the workstation computer 26 from web server 35 being directed by forms based input by the pharmacist. In particular, a forms based configuration enables those web-based service programs that the pharmacy has subscribed to and disables those web-based service programs that the pharmacy has not subscribed to. Forms based requests may also be used to create new patient records and update existing patient records. On submission of appropriate request, the web server 35 creates a new patient record in the former case or allows update of a patient record in the latter case.

The forms and web based content could be simultaneously displayed on the screen of pharmacy workstation computer 26. System 10 includes protective features to ensure that pharmacy personnel do not inadvertently change important web addresses (URLs) when web content is being downloaded and accessed for display on the screen of pharmacy computer workstation 26.

The computer system 10 may enable a number of pharmacy related service programs to be run through the plug-in application programs, two relating to the chronic health conditions diabetes and asthma and another program corresponds to blood pressure monitoring.

FIG. 9 shows a screen display in the browser window of pharmacy workstation 26 during running of an asthma screening program. In this case the patient has qualified for the asthma screening program through being prescribed the trigger medication Ventolin. Execution and use of the asthma screening program, again by web-based plug-in application program, as indicated by reference to web address, provides the patient a score 17—being off-target and recommending that the patient should visit her GP for advice. This recommendation is displayed at the bottom right of the browser window. This advice can be provided to the patient in real time during a visit to the pharmacy.

FIG. 10 shows a screen display at pharmacy workstation computer 26 during running of a diabetes screening program. Here a patient has qualified for the diabetes screening program by being prescribed a “trigger” medication, Orlistat. The patient's blood glucose measurement history is graphically displayed as the screening program is executed by the diabetes screening plug-in application program from web server 35. Even though the patient's history is displayed by a chart, covering a period of 15 weeks, in a window, the window is displaying data processed by, or obtained from, execution of the web-based diabetes screening plug-in program as indicated by reference to web address in the top left of the screen display.

The screen displays of FIGS. 9 and 10 are advisory tools available on the pharmacy workstation 26.

Referring to FIG. 11 there is shown a screen display at pharmacy workstation 26 during a blood pressure monitoring for a patient, Bob, having numeric identification code 3529 at a particular date. The patient's demographic information is recorded at the top 300 of the display. This information includes patient name, address and e-mail and phone contact details. Top 300 of the display also indicates the current date.

At 301 are recorded patient qualifications for the blood pressure monitoring pressure monitoring program. In particular, Bob suffers from qualifying preconditions diabetes and proteinuria as well as other predisposing conditions as checked in the boxes in this section of the display.

At portion 302 of the screen display are recorded Bob's current blood pressure measurements—systolic and diastolic—for left and right arms. The measurements are graphically displayed to the right of portion 302 of the screen display. Target blood pressure for various patient groups, including Bob's—is displayed and performance against those targets can be monitored by the pharmacist. “Traffic light indication” showing good performance (green), performance needing closer monitoring (orange) and performance requiring urgent action—perhaps by prescription of medication—is indicated by a red colour. The pharmacist may be advised to refer Bob to his doctor for further advice on the basis of the information displayed at portion 302, this display forming the advisory tool.

At portion 303 is recorded a history of Bob's blood pressure measurements together with any notes made by the pharmacist. Actions taken during running of the blood pressure monitoring program are recorded at portion 304 of the screen display.

At portion 305, Bob's blood pressure measurement history is graphically displayed.

The information from the screen display may be shown to Bob. The data, which is also recorded in the first database 20 of dispensing system server 21, may be printed in the form of a report as needed. Bob's data is also synchronised between first and second databases 20 and 30 following the protocol as above described.

Referring now to FIG. 12, only registered pharmacy workstations can interact with the web server 35. The workstation registration process for pharmacy workstation 26 proceeds as follows. In step R1, the user must correctly input credentials including username and password information as well as pharmacy identification code (“eGuild identifer”), this code possibly being assigned by a co-ordinator of a pharmacy network, to operate the workstation. Once step R1 is successfully completed, step R2 requires correct input of further credentials such as a web service identification code (“web service client eGuild identifier”) and dispense vendor identifier as well as username and password information. In step R3, the credentials information is confirmed by web server 35. At step R4, web server 35 checks that the request for workstation registration is legitimate. If the credentials are legitimate, workstation registration code (“pharmacy installation identifier”) and private key are created in step R5.

At step R6, the workstation registration code and private key are dispatched through the secure data network to the pharmacy workstation 26. This information is received in dispensing system 10 at step R7 and the result of the workstation registration code and private key dispatch operation (success or failure) displayed at the pharmacy workstation in step R8. Registration of the pharmacy workstation 26 for accessing the computer system 10 is now complete.

Modifications and variations to the computer system for identifying pharmacy related service programs for delivery to patients will be apparent to the skilled reader of this disclosure. Such modifications and variations are deemed within the scope of the present invention.

1. A computer system for identifying and delivering services to patients of a pharmacy, the computer system including:
an information module for obtaining and storing information about a pharmacy patient;
an electronic processing tool for processing said patient information from the information module and identifying at least one pharmacy related service program for delivery to a patient qualified for the service program based on said processed patient information;
an advisory tool enabling a pharmacy to advise a patient of said identified service program for said qualified patient; and
a service delivery module for delivering said at least one identified service program to said qualified patient by use of a plug-in application corresponding with said identified service program,
wherein the service deliver module delivers the service program developed by a party external to the pharmacy.

2. A computer system of claim 1 wherein said at least one service program is identified from a plurality of service programs deliverable by said service delivery module.

3. A computer system of claim 2 wherein said plurality of service programs includes a medication adherence service program.

4. A computer system of claim 2 being accessible only through a pharmacy computer under professional supervision.

5. A computer system of of claim 1 wherein said information module comprises a first database correspondent with the pharmacy and configured to store patient information for that pharmacy and said electronic processing tool of the computer system is interfaced to said first database to allow information stored in said first database to be processed for a single patient or a group of patients.

6. A computer system of claim 5 wherein said electronic processing tool comprises a database which stores patient information for a period of time to allow for electronic processing to occur at times limiting the load on the computerised pharmacy dispensing system.

7. A computer system of of claim 1 wherein patient information stored by the information module is compared, by the electronic processing tool, with one or more qualifications for admission to a service program, deliverable by the service delivery module, and about which information is held on a second or service database.

8. A computer system of claim 7 wherein said plug-in application is downloaded through a secure data network from a service computer system to the computerised pharmacy dispensing system for delivery of said at least one service program to a qualified patient.

9. A computer system of claim 8 wherein said secure data network is web based with a web server delivering plug-in applications on demand to the computerised pharmacy dispensing system.

10. A computer system of claim 8 comprising, where a patient is enrolled in a service program, a patient record in a first database of said information module and a corresponding record in said second or service database; and a synchronisation application for synchronising patient information held in said records.

11. An electronic processing tool for processing information about a pharmacy patient to identify a service for delivery to said patient; information for processing being obtained from an information module for obtaining and storing information about the pharmacy patient; the processing tool being communicable with an advisory tool enabling a pharmacy to advise the patient of a suitable service program for delivery to the patient and a service delivery module for delivering said service program to said patient by use of a plug-in application corresponding with said service program wherein the service delivery module delivers the service program developed by a party external to the pharmacy.

12. A method for identifying and delivering services to patients of a pharmacy comprising
obtaining and storing information about a pharmacy patient in an information module;
processing said patient information from the information module using an electronic processing tool and identifying at least one pharmacy related service program for delivery to a patient qualified for the service program based on said processed patient information;
advising a patient of said identified service program or said qualified patient; and
delivering said at least one identified service program to said qualified patient from a service delivery module by use of a plug-in application corresponding with said identified service program,
wherein the service delivery module delivers the service program developed by a party external to the pharmacy.

13. A computer system of claim 2 wherein said information module comprises a first database correspondent with the pharmacy and configured to store patient information for that pharmacy and said electronic processing tool of the computer system is interfaced to said first database to allow information stored in said first database to be processed for a single patient or a group of patients.

14. A computer system of claim 3 wherein said information module comprises a first database correspondent with the pharmacy and configured to store patient information for that pharmacy and said electronic processing tool of the computer system is interfaced to said first database to allow information stored in said first database to be processed for a single patient or a group of patients.

15. A computer system of claim 4 wherein said information module comprises a first database correspondent with the pharmacy and configured to store patient information for that pharmacy and said electronic processing tool of the computer system is interfaced to said first database to allow information stored in said first database to be processed for a single patient or a group of patients.

16. A computer system of claim 2 wherein patient information stored by the information module is compared, by the electronic processing tool, with one or more qualifications for admission to a service program, deliverable by the service delivery module, and about which information is held on a second or service database.

17. A computer system of claim 3 wherein patient information stored by the information module is compared, by the electronic processing tool, with one or more qualifications for admission to a service program, deliverable by the service delivery module, and about which information is held on a second or service database.

18. A computer system of claim 5 wherein patient information stored by the information module is compared, by the electronic processing tool, with one or more qualifications for admission to a service program, deliverable by the service delivery module, and about which information is held on a second or service database.

19. A computer system of claim 6 wherein patient information stored by the information module is compared, by the electronic processing tool, with one or more qualifications for admission to a service program, deliverable by the service delivery module, and about which information is held on a second or service database.

20. A computer system of claim 9 comprising, where a patient is enrolled in a service program, a patient record in a first database of said information module and a corresponding record in said second or service database; and a synchronisation application for synchronising patient information held in said records.
